(19) United States
(12) Patent Application Publication
(10) Pub. No.: US 2026/0138934 A1
(43) Pub. Date: May 21, 2026

(54) BODILY REMAINS DECOMPOSITION

(71) Applicant: Verde Products, Inc., Wildwood, MO (US)

(72) Inventor: Robert L. Jenkins, Wildwood, MO (US)

(21) Appl. No.: 18/949,791

(22) Filed: Nov. 15, 2024

(51) Int. Cl. C05F 1/00; A01C 21/00; C05D 9/00; C05F 5/00; C05F 9/00; C05G 3/80; C05G 5/40; C09K 17/44

(52) U.S. Cl. CPC C05F 1/00; A01C 21/00; C05D 9/00; C05F 5/002; C05F 9/00; C05G 3/80; C05G 5/40; C09K 17/44

(57) ABSTRACT

An organic composition for decomposing bodily remains includes a composite mixture of compost, bark fines, sulfur, and gypsum. The composite mixture is configured to combine with the bodily remains to decompose the bodily remains. The combined mixture has a reduced pH such that when the combined mixture is buried in soil, the combined mixture reduces the detrimental effects of the bodily remains on the soil and surrounding environment and improves moisture retention in the soil thereby improving soil health.

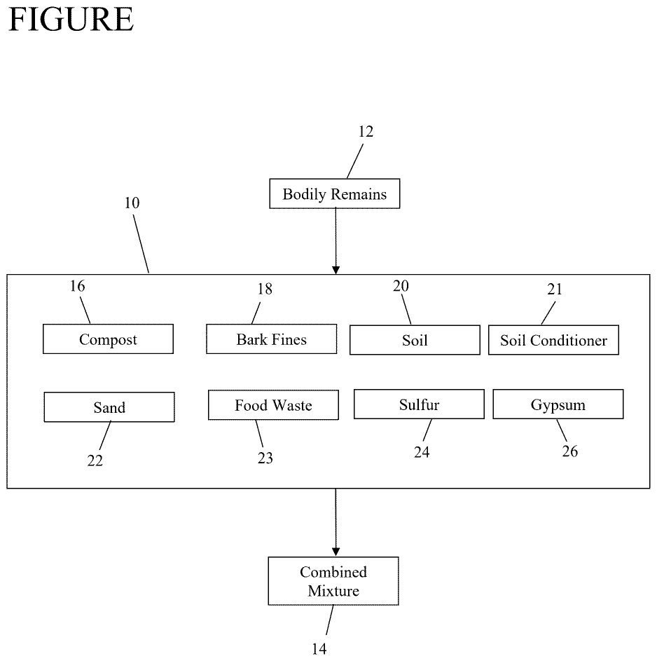

### FIELD

The present disclosure generally relates to the decomposition of bodily remains. In particular, the present disclosure relates to a composite material for decomposing cremation and/or non-cremated burial remains while improving soil health.

### BACKGROUND

Memorializing the deceased is typically done using cremation or non-cremation burial, with or without the body contained within a casket or other enclosure. Cremation is the combustion, vaporization and oxidation of cadavers to basic elements of bone and mineral fragments. The modern cremation process uses large, high-powered furnaces called cremators. The cremation process destroys all traces of organic, carbon-based matter and all bodily fluids evaporate and escape through the cremator's exhaust. The only thing remaining of the body after cremation is part of the skeletal structure containing small amounts of salts and minerals.

Cremation remains are usually placed in a container and stored as a memorial, scattered into the environment, or buried into the earth. The toxic levels of sodium and high alkalinity levels of the cremation remains can be harmful to the environment. In particular, cremation remains can damage plants and alter the soil composition when the remains are placed in or around plant life. Non-cremated remains are typically buried and can also be harmful to the environment.

### SUMMARY

In one aspect, an organic composition for decomposing bodily remains generally comprises a composite mixture including or consisting essentially of compost, bark fines, sulfur, and gypsum. The composite mixture is configured to combine with the bodily remains to decompose the bodily remains. The combined mixture has a reduced pH such that when the combined mixture is buried in soil, the combined mixture reduces the detrimental effects of the bodily remains on the soil and surrounding environment and improves moisture retention in the soil thereby improving soil health.

In another aspect, a method of making an organic composition for decomposing bodily remains generally comprises mixing together a composite mixture including or consisting essentially of compost, bark fines, sulfur, and gypsum. The composite mixture is configured to combine with the bodily remains to decompose the bodily remains. The combined mixture has a reduced pH such that when the combined mixture is buried in soil, the combined mixture reduces the detrimental effects of the bodily remains on the soil and surrounding environment and improves moisture retention in the soil, thereby improving soil health.

In yet another aspect, a method of treating bodily remains for decomposing the bodily remains generally comprises mixing together a composite mixture including or consisting essentially of compost, bark fines, sulfur, and gypsum. The method further comprises adding a prescribed amount of the composite mixture to a prescribed amount of the bodily remains such that the composite mixture combines with the bodily remains to decompose the bodily remains. The combined mixture has a reduced pH such that when the combined mixture is buried in soil, the combined mixture reduces the detrimental effects of the bodily remains on the soil and surrounding environment and improves moisture retention in the soil, thereby improving soil health.

In still another aspect, an organic composition for decomposing bodily remains generally comprises a composite mixture configured to combine with the bodily remains to decompose the bodily remains. The combined mixture having a pH of less than about 7 such that when the combined mixture is buried in soil, the combined mixture reduces the detrimental effects of the bodily remains on the soil and surrounding environment and improves moisture retention in the soil, thereby improving soil health.

### BRIEF DESCRIPTION OF THE DRAWINGS

FIGURE is a schematic illustration of a process of combining a composite material with bodily remains for decomposing the bodily remains.

Corresponding reference characters indicate corresponding parts throughout the drawings.

### DETAILED DESCRIPTION

Referring now to the Figure, a composite mixture 10 is schematically illustrated. The composite mixture 10 is configured (i.e., designed and constructed) to break down bodily remains 12 (e.g., cremation and non-cremated burial remains) to reduce the detrimental effects the remains may have on the environment. In one embodiment, the composite mixture 10 is used to decompose cremation remains. The composite mixture 10 mixes with the bodily remains 12 to produce a combined mixture 14 having a reduced pH as compared to the pH of the bodily remains prior to being mixed with the composite mixture. For example, the pH of bodily remains, such as cremation remains, may be between about 10 and 12. Adding the composite mixture 10 to the remains 12 suitably produces a pH of the combined mixture 14 of about 7 or less. In one embodiment, the pH of the combined mixture 14 is less than about 6.8. In one embodiment, the pH of the combined mixture 14 is about 3. Reducing the pH reduces alkalinity, making the combined mixture 14 less harmful to the environment as compared to the bodily remains 12 alone or without the composite mixture 10. Adding the composite mixture 10 to the bodily remains 12 also dilutes the sodium levels of the remains making the remains less toxic. In addition to the pH and sodium levels, adding the mixture 10 to the bodily remains 12 also improves moisture retention in the soil which improves the health of the soil in which the combined mixture is buried. Thus, the combined mixture 14 is significantly more conducive to promoting plant growth than the bodily remains 12 prior to treatment with the mixture 10. The composite mixture 10 can be used for the decomposition of human or pet remains. In one embodiment, the composite mixture 10 is 100% organic, meaning there are no artificially produced chemicals or additives in the mixture.

In the illustrated embodiment, the composite mixture 10 includes a combination of compost 16, bark fines 18, soil 20, soil conditioner 21, sand 22, food waste 23, sulfur 24, and gypsum 26. The compost 16 may include leaf compost, lawn waste, or any other suitable compost material. In a preferred embodiment, the compost comprises leaf mold compost. Composting is the controlled, aerobic (oxygen-required) biological decomposition of organic materials by microorganisms. The leaf mold compost 16 may have the advantage of increasing active soil organic matter and beneficial soil microbes. The leaf mold compost 16 can also increase survival of a beneficial microbial inoculant in the soil. Additionally, leaf mold compost 16 can reduce foliar disease and improve soil structure while retaining moisture. The composite mixture 10 could have additional components not mentioned, or only some of the components mentioned, without departing from the scope of the disclosure. For example, the composite mixture 10 may also include saw dust. Additionally, in one embodiment, the mixture 10 is free of peat. In one or other embodiments, the composite mixture 10 may include or consist essentially of compost 16, bark fines 18, sulfur 24, and gypsum 26.

In use, a prescribed amount of the mixture 10 is combined with a prescribed amount of bodily remains 12 so that the mixture can effectively decompose the remains. In one embodiment, about 1-part of remains 12 is mixed with about 10-parts of composite mixture 10 to accomplish the desired level of decomposition of the remains. For example, when storing the remains 12 in a pot or container it may be desirable to use the 1 to 10 ratio. However, other ratios can be used without departing from the scope of the disclosure. In one embodiment, about 1-part remains 12 are mixed with about 1-part composite mixture 10. For example, when burying or scattering cremation remains it may be desirable to use about a 1 to 1 ratio of remains 12 to composite mixture 10. However, other ratios can be used without departing from the scope of the disclosure.

The composite mixture 10 can comprise between about 10% and about 20% compost, between about 30% and about 70% bark fines 18, between about 5% and about 10% sand 22, between about 1% and about 10% of food waste 23, between about 5% and about 10% soil 20, between about 5% and about 15% of soil conditioner 21, between about 0.01% and about 1.0% gypsum 26, and about 5 lbs/50 cubic yards of sulfur 24. In one embodiment, the composite mixture 10 comprises about 50% bark fines 18, about 15% compost 16, about 10% soil 20, about 10% soil conditioner, about 5% sand 22, about 5% of food waste 23, about 0.01% gypsum 26, and about 5 lbs/50 cubic yards of sulfur 24. Other percentages for each component may be used without necessarily departing from the scope of the disclosure.

The bark fines 18 provide the mixture 10 with a low pH such that when the mixture is added to the bodily remains 12 (e.g., ashes) the combined mixture 14 it will be low enough to activate growth while not adversely affecting the surrounding areas. The low pH will also help with the uptake of nutrients into any plants that are planted in the combined mixture 14. The low pH also helps with the sodium content (alongside irrigation). Additionally, the bark fines 18 will continue to increase in pH over time, thereby adding further nutrients to the soil. Thus, the low pH of the combined mixture 14 is configured to sustain growth and give a buffer for the burial/plant area over a duration of time so that the area maintains a relatively low pH over time.

The soil conditioner 21 is configured to alter the structure of soil. For example, the soil conditioner 21 can improve the soil's ability to aggregate (i.e., hold itself together), how well the soil holds or drains water, and how easily oxygen is able to penetrate into the soil. The soil conditioner 21 can also increase the cation exchange capacity (CEC) of the soil. This refers to the relative ability of the soil to store nutrients in the form of positively charged particles called cations. The most common soil cations include calcium, magnesium, potassium, and ammonium, each of which are found in cremated remains. The total number of cations a soil can hold (otherwise put, its total negative charge) is the soil's cation exchange capacity. The higher the CEC, the more cations that can be held and exchanged with plant roots, providing them with the nutrients they need. The soil conditioner 21 may also be used to improve the water holding capacity of the soil, particularly in droughty coarse soils such as sandy soils, which drain quickly. In one embodiment, the soil conditioner 21 comprises humic acid. Humic acid is a natural soil conditioner that improves soil structure and helps plants take in nutrients. Humic acid has a carbon matrix with organic acids and trace minerals.

Regarding the food waste 23, composting wasted food with other organic materials like yard trim produces a valuable, stable soil amendment that can be used to build soil health, increase soil water retention, and reduce soil erosion. Producing and using compost recycles organic matter and nutrients that are important for long-term soil health and ecosystem resilience. The inclusion of food waste 23 in the mixture 10 provides a natural pH lowering mechanism.

The inclusion of sulfur 24 and gypsum 26 into the composite mixture 10 reduces the pH and dilute the sodium levels when the composite mixture 10 is combined with the bodily remains 12. The sand 22 reduces compaction of the combined mixture 14 which is advantageous in the decomposition process. Depending on the amount of bodily remains 12, the composite mixture 10 may take up to about 3 months to break down the bones of the remains when the combined mixture 14 is not buried. It will be understood that the decomposition time may vary depending on the bodily remains 12 and the manner in which the remains are held.

The composite mixture 10 can be aged prior to being combined with the bodily remains 12 to facilitate growth of bacteria that is useful in decomposing the bodily remains. In one embodiment, the composite mixture 10 is aged outside such that the composite mixture is exposed to the surrounding environment during the aging process. Thus, the aging process may be dependent on the environment in which the mixture is aged. For example, a lower ambient temperature may produce a higher internal combustion temperature within the composite mixture 10 which in turn facilitates the aging process. In addition, a humid environment may enhance aging. In one embodiment, the composite mixture 10 is aged for at least about 3 months. In one embodiment, the composite mixture 10 is aged for about 6 to about 24 months. During the aging process, the composite mixture 10 can be stirred or turned regularly to facilitate the growth of the bacteria. In one embodiment, the composite mixture 10 is stirred at least once per month. Stirring the composite mixture 10 can accelerate the aging process. For instance, in certain environments, aging may take only about 6 weeks when the mixture is stirred. The mixture 10 can be aged for a different duration or time and/or stirred at a different rate without departing from the scope of the disclosure.

When introducing elements of aspects of the invention or the examples and embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several examples, embodiments, adaptations, variations, alternatives and uses of the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various examples and embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An organic composition for decomposing bodily remains comprising a composite mixture, wherein the composite mixture includes compost, bark fines, sulfur, and gypsum, the composite mixture being configured to combine with the bodily remains to decompose the bodily remains, the combined mixture having a reduced pH such that when the combined mixture is buried in soil, the combined mixture reduces the detrimental effects of the bodily remains on the soil and surrounding environment and improves moisture retention in the soil thereby improving soil health.

2. The composition of claim 1, wherein the composite mixture comprises between about 10% and about 20% compost, between about 30% and about 70% bark fines, between about 0.01% and about 1.0% gypsum, and about 5 lbs/50 cubic yards of sulfur.

3. The composition of claim 2, wherein the composite mixture further comprises soil and food waste.

4. The composition of claim 3, wherein the composite mixture comprises between about 5% and about 10% soil and between about 1% and about 10% food waste.

5. The composition of claim 1, wherein the composite mixture comprises about 15% compost, about 50% bark fines, about 0.01% gypsum, and about 5 lbs/50 cubic yards of sulfur.

6. The composition of claim 5, wherein the composite mixture further comprises about 10% soil and about 5% food waste.

7. The composition of claim 1, wherein the composite mixture further comprises a soil conditioner configured to alter the structure of the soil.

8. The composition of claim 7, wherein the composite mixture comprises between about 5% and about 15% soil conditioner.

9. The composition of claim 1, wherein the composite mixture is free of peat.

10. A method of making an organic composition for decomposing bodily remains, the method comprising mixing together a composite mixture including compost, bark fines, sulfur, and gypsum, the composite mixture being configured to combine with the bodily remains to decompose the bodily remains, the combined mixture having a reduced pH such that when the combined mixture is buried in soil, the combined mixture reduces the detrimental effects of the bodily remains on the soil and surrounding environment and improves moisture retention in the soil thereby improving soil health.

11. The method of claim 10, wherein the composite mixture comprises between about 10% and about 20% compost, between about 30% and about 70% bark fines, between about 0.01% and about 1.0% gypsum, and about 5 lbs/50 cubic yards of sulfur.

12. A method of treating bodily remains for decomposing the bodily remains, the method comprising:
providing a composite mixture; and
adding a prescribed amount of the composite mixture to a prescribed amount of the bodily remains such that the composite mixture combines with the bodily remains to decompose the bodily remains, the combined mixture having a reduced pH such that when the combined mixture is buried in soil, the combined mixture reduces the detrimental effects of the bodily remains on the soil and surrounding environment and improves moisture retention in the soil thereby improving soil health.

13. The method of claim 12, wherein the composite mixture includes compost, bark fines, sulfur, and gypsum.

14. The method of claim 12, wherein the combined mixture has a pH that is reduced from a pH of the bodily remains prior to being combined with the composite mixture.

15. The method of claim 14, wherein the combined mixture has a pH equal to or less than about 7.

16. The method of claim 12, wherein the bodily remains comprise one of cremation and non-cremated burial remains.

17. The method of claim 12, wherein the bodily remains comprise human or pet remains.

18. An organic composition for decomposing bodily remains comprising a composite mixture configured to combine with the bodily remains to decompose the bodily remains, the combined mixture having a pH of less than about 7 such that when the combined mixture is buried in soil, the combined mixture reduces the detrimental effects of the bodily remains on the soil and surrounding environment and improves moisture retention in the soil thereby improving soil health.

19. The composition of claim 18, wherein the composite mixture includes compost, bark fines, sulfur, and gypsum.

20. The composition of claim 19, wherein the composite mixture further comprises food waste.
